(19) United States
(12) Patent Application Publication
(10) Pub. No.: US 2026/0228697 A1
(43) Pub. Date: Aug. 6, 2026

(54) SYSTEMS AND METHODS FOR BIDIRECTIONAL JOB MATCHING IN EMPLOYMENT PLATFORMS

(71) Applicant: Yvonne L. Smith, Frederick, MD (US)

(72) Inventor: Yvonne L. Smith, Frederick, MD (US)

(21) Appl. No.: 19/439,648

(22) Filed: Jan. 5, 2026

Related U.S. Application Data
(60) Provisional application No. 63/754,890, filed on Feb. 6, 2025.

(51) Int. Cl. G06Q 10/1053; G06Q 10/0631

(52) U.S. Cl. CPC G06Q 10/1053; G06Q 10/063112

(57) ABSTRACT

In some implementations of the present disclosure, a system for matching between a plurality of users seeking employment and a plurality of positions of employers, may include one or more processors and memory. The one or more processors may receive, via a first user interface, first information relating to a desired position of a first user of the plurality of users, the first information comprising at least one of an occupation code, an experience level, a job title, a job function, or a description on the first user. The one or more processors may determine, based on the first information, from among the plurality of positions of employers, one or more positions of one or more employers. In response to the determined one or more positions of the one or more employers, the one or more processors may transmit the first information to the first user.

### CROSS-REFERENCE TO RELATED APPLICATIONS

This application claims the benefit of and priority to U.S. Provisional Application No. 63/754,890, filed on February 6, 2024, which is incorporated herein by reference in its entirety for all purposes.

### TECHNICAL FIELD

The present disclosure relates to systems and methods for employment onboarding in employment platforms and more particularly to systems and methods for matching between users seeking employment and positions of employers.

### BACKGROUND

Day laborers often face barriers to quick employment due to the need for rapid and accurate onboarding. Employers need completed employment verification forms (e.g., I-9 form) and tax forms (e.g., W-4 form) along with supporting documentation before a laborer can begin work. Conventional employment onboarding processes are fragmented, requiring manual paperwork and in-person verification, which may slow down the hiring process.

### SUMMARY

Implementations of the present disclosure relate to a system and a method for employment onboarding (or integration) in employment platforms and more particularly to a system and a method for matching between users seeking employment and positions of employers.

In some implementations of the present disclosure, a system for matching between a plurality of users seeking employment and a plurality of positions of employers, may include one or more processors and memory. The one or more processors may be configured to receive, via a first user interface, first information relating to a desired position of a first user of the plurality of users, the first information comprising at least one of an occupation code, an experience level, a job title, a job function, or a description on the first user. The one or more processors may be configured to determine, based on the first information, from among the plurality of positions of employers, one or more positions of one or more employers. In response to the determined one or more positions of the one or more employers, the one or more processors may be configured to transmit the first information to the first user.

In some implementations of the present disclosure, a method for matching between a plurality of users seeking employment and a plurality of positions of employers, may include receiving, by one or more processors via a first user interface, first information relating to a desired position of a first user of the plurality of users, the first information including at least one of an occupation code, an experience level, a job title, a job function, or a description on the first user. The method may include determining, by the one or more processors based on the first information, from among the plurality of positions of employers, one or more positions of one or more employers. The method may include in response to the determined one or more positions of the one or more employers, transmitting, by the one or more processors, the first information to the first user.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 is a block diagram illustrating an example of a system environment for an employment system according to some implementations.

FIG. 2 is a block diagram illustrating an example of a computing system according to some implementations.

FIG. 3 is an example user interface for logging into an employment platform according to some implementations.

FIG. 4 is an example user interface for uploading forms and/or documents for employment of a user (e.g., a day laborer), according to some implementations.

FIG. 5 is an example user interface for a day laborer to enter title and type of desired jobs (e.g., desired positions of employers) and the experience level of the day laborer, according to some implementations.

FIG. 6 is an example user interface for searching for desired jobs (e.g., desired positions of employers), according to some implementations.

FIG. 7 is an example user interface for displaying one or more jobs completed by a day laborer and documentation on the day laborer, according to some implementations.

FIG. 8 is an example user interface for displaying one or more upcoming jobs or works assigned to a day laborer, according to some implementations.

FIG. 9 is an example user interface for displaying information of an employer and one or more jobs posted by the employer, according to some implementations.

FIGS. 10A and FIG. 10B are example user interfaces for searching for a day laborer, according to some implementations.

FIG. 11 is an example user interface for creating a job card (e.g., job announcement, job post, recruiting card, recruiting announcement, recruiting post) according to some implementations.

FIG. 12 is an example user interface for finalizing a tax form for a day laborer to begin to work on one or more jobs, according to some implementations.

FIG. 13 is an example user interface for displaying information of a hired day laborer, according to some implementations.

FIG. 14 is an example user interface for displaying one or more work requests sent by an employer to one or more day laborers or one or more work requests sent by one or more day laborers to the employer, according to some implementations.

FIG. 15 is a flowchart illustrating an example methodology for matching between users seeking employment and positions of employers, according to some implementations.

### DETAILED DESCRIPTION

According to certain aspects, implementations in the present disclosure relate to a system and a method for employment onboarding (or integration) in employment platforms and more particularly to a system and a method for matching between users seeking employment and positions of employers.

Day laborers often face barriers to quick employment due to the need for rapid and accurate onboarding. Employers need completed employment verification forms (e.g., I-9 form) and tax forms (e.g., W-4 form) along with supporting documentation before a laborer can begin work. Conventional employment onboarding processes are fragmented, requiring manual paperwork and in-person verification, which may slow down the hiring process.

To solve the above-noted problems, according to certain aspects, an employment system (referred to as “system”) can streamline the onboarding/hiring process through a mobile application that stores and transfers documents to the employer seamlessly. In some implementations, the system can onboard (e.g., integrate, hire) day laborers by allowing the day laborers to electronically complete essential employment documents and create an introductory video, all within a mobile application. In some implementations, the system can enable users to electronically complete necessary employment forms (e.g., I-9, W-4), upload supporting documentation, and create a video (e.g., 30-second introductory video). In some implementations, these documents and data can be securely stored within the system and can be transmitted to employers when the day laborer is hired for a shift. In some implementations, the system can ensures that day laborers are prepared to begin work immediately, simplifying the hiring process for both laborers and employers.

In some implementations, the system can perform an enhanced bidirectional job-matching process (e.g., job-matching method, job-matching algorithm) between users seeking jobs and available positions of employers. In some implementations, the system can perform a dynamic tax lookup and/or a dynamic tax calculation. For example, for a position/job/work of an employer, the system can determine the state and city where the work is being prepared (e.g., employer’s location). For a user (e.g., day laborer) seeking the position/job/work, the system can determine the employee’s W-4 form data, such as filing status and allowances, determine the hourly compensation offered to the user by the employer.

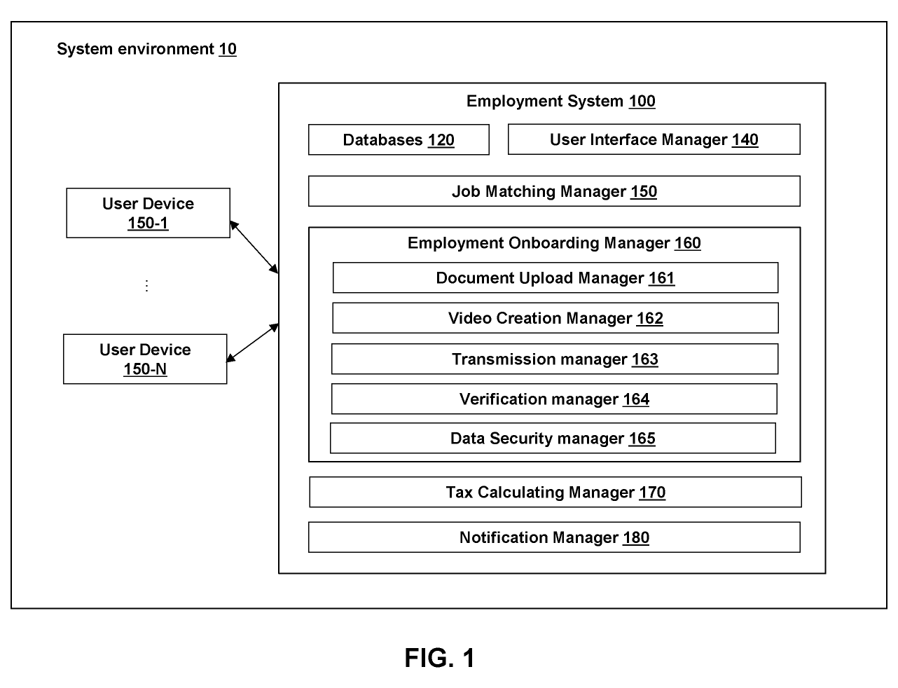

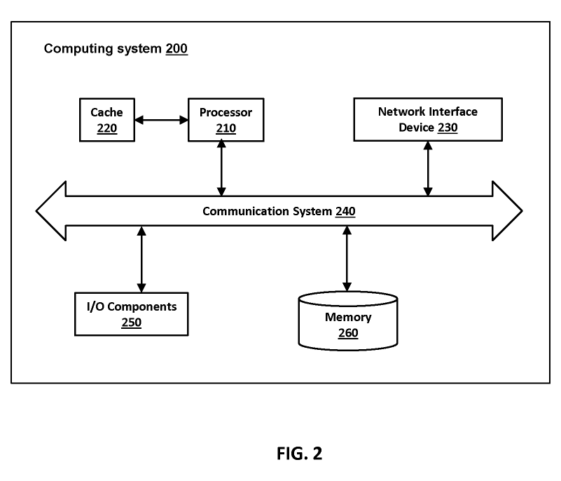

FIG. 1 is a block diagram illustrating an example of a system environment 10 for an employment system 100 according to some implementations. Referring to FIG. 1, the system 100 may be an employment system, an employment onboarding system, a job matching system, an employment management system, or a tax calculating system. The system 100 may be coupled or paired with a plurality of user devices 120-1 to 120-N. Each of the plurality of user devices may be used by one or more users. The one or more users may include one or more employers and/or one or more job seekers (e.g., day laborers). In some implementations, the system 100 may be connected to the plurality of user devices 120-1 to 120-N via a network. Here, the network may be a Local Area Network (“LAN”), a wide area network (“WAN”), a wireless network, and/or the Internet, among others. The wireless network may be the IEEE 802.11 protocols, near field communication (NFC), Bluetooth, ANT, or any other wireless protocol, among others. Each of the system 100 and the plurality of user devices 120-1 to 120-N may have configurations similar to those of computing system 200 in FIG. 2.

In some implementations, the system 100 may include a user interface manager 140 (e.g., user interface module), a job matching manager 150 (e.g., a job matching module, a matching module), an employment onboarding manager 160 (e.g., an employment onboarding module, an employment management module), a tax calculating manager 170 (e.g., a tax calculating module, a tax lookup manager, a tax lookup module), and/or a notification manager 180 (e.g., a notification module), which will be described in more details in the following sections. In some embodiments, at least one or more of the user interface manager 140, the job matching manager 150, the employment onboarding manager 160, the tax calculating manager 170, or the notification manager 180 may be implemented with a circuit (e.g., circuitry of a FPGA, CPU, GPU or other processing circuits implemented using electronic circuits), a subroutine in a program stored in memory (e.g., EPROM, EEPROM, SDRAM, and flash memory devices, CD ROM, DVD-ROM, or Blu-Ray® discs and the like) and executable by a processor (e.g., CPU, GPU and the like), or the like.

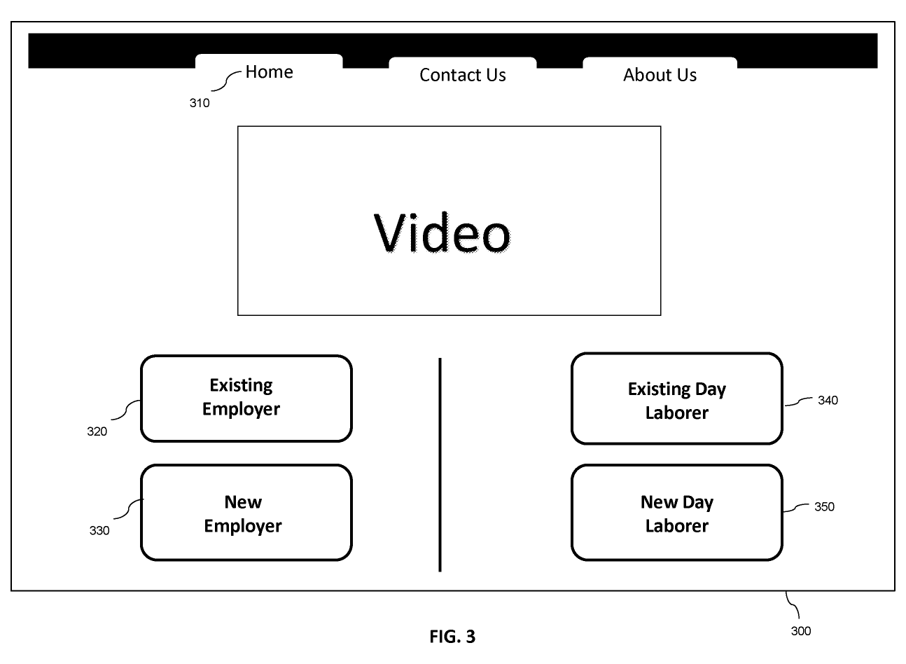

In some implementations, the system 100 may include one or more databases 120 to store data managed by one or more of the user interface manager 140, the job matching manager 150, the employment onboarding manager 160, the tax calculating manager 170, or the notification manager 180 (e.g., data relating to user interfaces, job matching, employment position data, reviews, employers, job seekers, job applications, photos or videos, tax, employment forms, notifications, etc.). In some implementations, the user interface manager 140 may generate user interfaces (e.g., graphical user interfaces shown in FIGS. 3-14) for displaying data or receiving input to perform functions of the job matching manager 150, the employment onboarding manager 160, the tax calculating manager 170, or the notification manager 180.

In some implementations, the employment onboarding manager (“onboarding manager”) 160 can streamline employment onboarding for day laborers through a mobile application (e.g., an application running on a user device 150-1) and enable users to electronically complete necessary employment forms (e.g., I-9, W-4), upload supporting documentation, and/or create a 30-second introductory video. These documents and data can be securely stored within the system and are transmitted to employers when the day laborer is hired for a shift. The onboarding manager 160 can ensure that day laborers are prepared to begin work immediately, simplifying the hiring process for both laborers and employers.

In some implementations, the user interface manager 140 can create, generate, or render a user interface (on a user device 150-1, for example) that enables a day laborer to complete an I-9 employment verification form electronically. The onboarding manager 160 can include a document upload manager 161 that allows the day laborer to upload supporting documentation related to employment eligibility, an electronic W-4 form that enables the day laborer to complete and submit federal tax withholding information, and a video creation manager 162 that allows the day laborer to record and upload a 30-second introductory video showcasing their skills and experience. The database 120 can be configured to store the completed forms, uploaded documents, and video. The onboarding manager 160 can include a transmission manager 163 configured to securely transmit the stored documents, forms, and video to an employer upon successful matching of the day laborer with a job.

In some implementations, the onboarding manager 160 can include a verification manager 164 that ensures the I-9 form is accurately completed and all necessary supporting documents are uploaded according to federal guidelines. The onboarding manager 160 can include a data security manager 165 that ensures that stored data, including the I-9 and W-4 forms, are encrypted to ensure data security and compliance with relevant privacy regulations.

In some implementations, the onboarding manager 160 can receive input from a day laborer completing an I-9 employment verification form through a user interface (e.g., a mobile interface or user interface 400), enabling the day laborer to upload supporting documentation associated with employment verification, receiving input from the day laborer completing a W-4 form, recording and storing a 30-second introductory video uploaded by the day laborer, matching the day laborer to an employer based on job preferences and experience (e.g., user interface 500), and transmitting the stored tax forms and proof of identification to the employer once the day laborer and employer have secured a job (e.g., user interface 700). The onboarding manager 160 ensures that day laborers are prepared to begin work immediately, simplifying the hiring process for both laborers and employers.

In some implementations, the onboarding manager 160 can enable day laborers to complete I-9 and W-4 forms, upload supporting documents, and/or record a short introductory video (e.g., user interface 400). The data can be securely stored and made accessible to employers when the laborer is hired for a shift. The onboarding manager 160 can ensure that the necessary documentation is ready for immediate submission, expediting the onboarding process.

In some implementations, the onboarding manager 160 can facilitate employment onboarding of day laborers via a mobile application (e.g., mobile application running on a user device 150-1). The user interface manager 140 can enable a day laborer to complete an I-9 employment verification form electronically, a document upload module that allows the day laborer to upload supporting documentation related to employment eligibility, and an electronic W-4 form that enables the day laborer to complete and submit federal tax withholding information (e.g., user interface 400, 700). Additionally, the onboarding manager 160 can include the video creation manager 162 that allows the day laborer to record and upload a 30-second introductory video showcasing their skills and experience. All completed forms, uploaded documents, and videos can be stored in the database 120, which is configured to securely transmit the stored documents, forms, and video to an employer via the transmission manager 163 upon successful matching of the day laborer with a job. This can allow the employer to access the stored documents and video prior to the start of the day laborer’s shift, facilitating faster onboarding (e.g., user interface 1000).

In some implementations, the onboarding manager 160 can include the verification manager 164 that ensures the I-9 form is accurately completed and all necessary supporting documents are uploaded according to federal guidelines. the onboarding manager 160 can support integration with state-specific tax forms in addition to the federal W-4 form. The video creation manager 162 can time-restrict the day laborer’s video submission to a 30-second maximum and allow the user to edit and resubmit the video before final submission. To ensure data security and compliance with relevant privacy regulations, all stored data, including the I-9 and W-4 forms, can be encrypted.

In some implementations, the onboarding manager 160 can verify that all mandatory fields on the I-9 form are completed accurately before allowing the day laborer to submit the form. Employers can access the stored W-4, I-9 form, and supporting documents once the day laborer has arrived at the work site and granted permission. The day laborer may bring hard copies of supporting documentation for the employer to verify before beginning the shift.

In some implementations, the user interface manager 140 can allow the day laborer to access the mobile application and complete a series of steps, including filling out an I-9 form, uploading identity verification documents, and completing a W-4 form. The day laborer can be prompted to record a 30-second video introducing their experience and skills. All entered data and uploaded files can be stored securely in the encrypted database 120, ensuring compliance with federal data privacy regulations, including those related to Personally Identifiable Information (PII). The verification manager 164 can perform an I-9 verification process to ensure that all fields are filled out properly, and the notification manager 180 can alert the user if any mandatory information is missing. When a laborer is selected for a job, the transmission manager 163 can automatically send the completed I-9, W-4, and video to the employer through a secure transmission process, ensuring that the necessary paperwork is completed before the laborer starts their shift.

In some implementations, the job matching manager 150 can allow a mobile application (running on a user device) to store information related to the day laborer’s experience level, job history, and preferred job types (e.g., user interface 500), and integrate this information into a job-matching algorithm. The job matching manager 150 can include a "Dream Job" feature, allowing day laborers to enter aspirational job titles in their profile (even though they have no experience relating to the aspirational job titles). The job matching manager 150 can track dream job preferences and highlight the dream job preferences for employers who may be willing to train or hire workers with no experience in those roles.

In some implementations, the job matching manager 150 can perform an enhanced bidirectional job-matching algorithm for day laborers. The job matching manager 150 can categorize experience into four fields: "Expert" (more than 5 years of experience, for example), "Skilled" (2-5 years of experience, for example), "Entry-Level" (less than 2 years of experience, for example), and "Aspiring" (dream job with no experience, for example). In some implementations, the job matching manager 150 can allow a user (e.g., day laborer) who is an “Expert” to select the appropriate Bureau of Labor Statistics (BLS) Standard Occupational Classification (SOC) Code at the NAICS 6-digit code for jobs held for more than 5 years. The job matching manager 150 can allow a user (e.g., day laborer) who is a “Skilled” worker to select codes/titles for jobs held at the NAICS 6-digit code for 2-5 years (e.g., user interface 500). The job matching manager 150 can allow a user (e.g., day laborer) who is an entry-level worker to select codes/titles for jobs held at the NAICS 6-digit code for less than 2 years. The job matching manager 150 can allow aspiring workers to select codes/titles that are considered dream jobs at the NAICS 6-digit code but have no experience. The output for day laborers can include job postings matches (e.g., user interface 600) sorted by exact matches, followed by adaptive, functional, and dreamer.

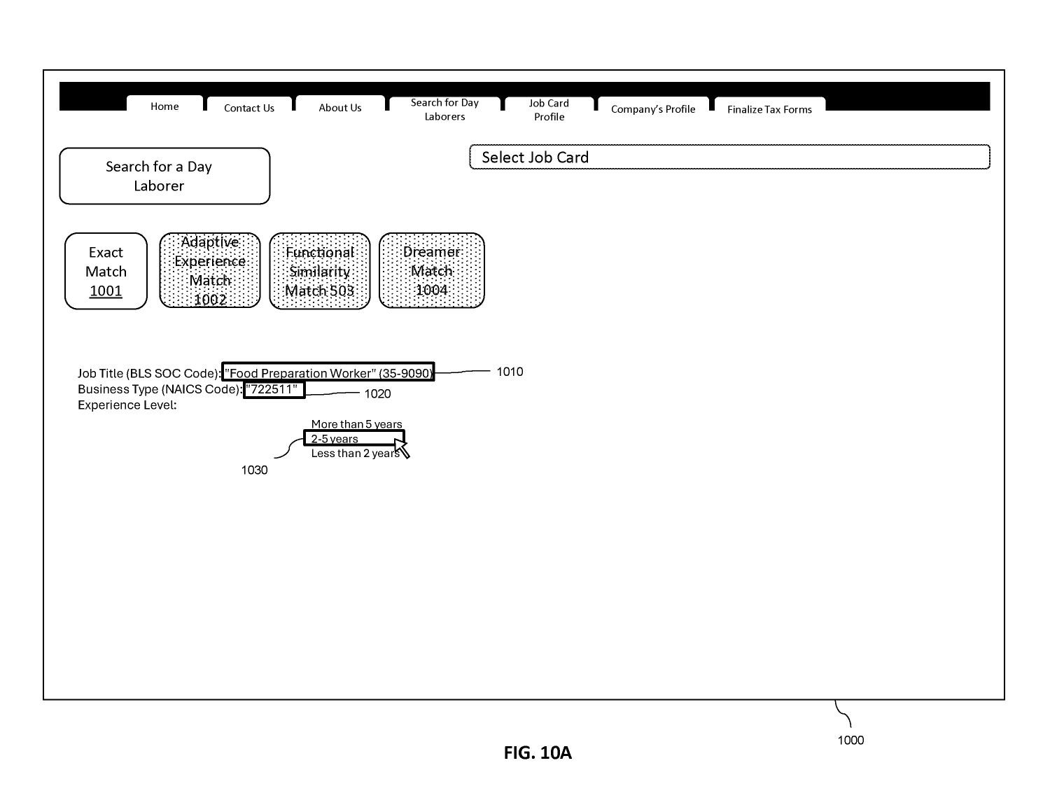

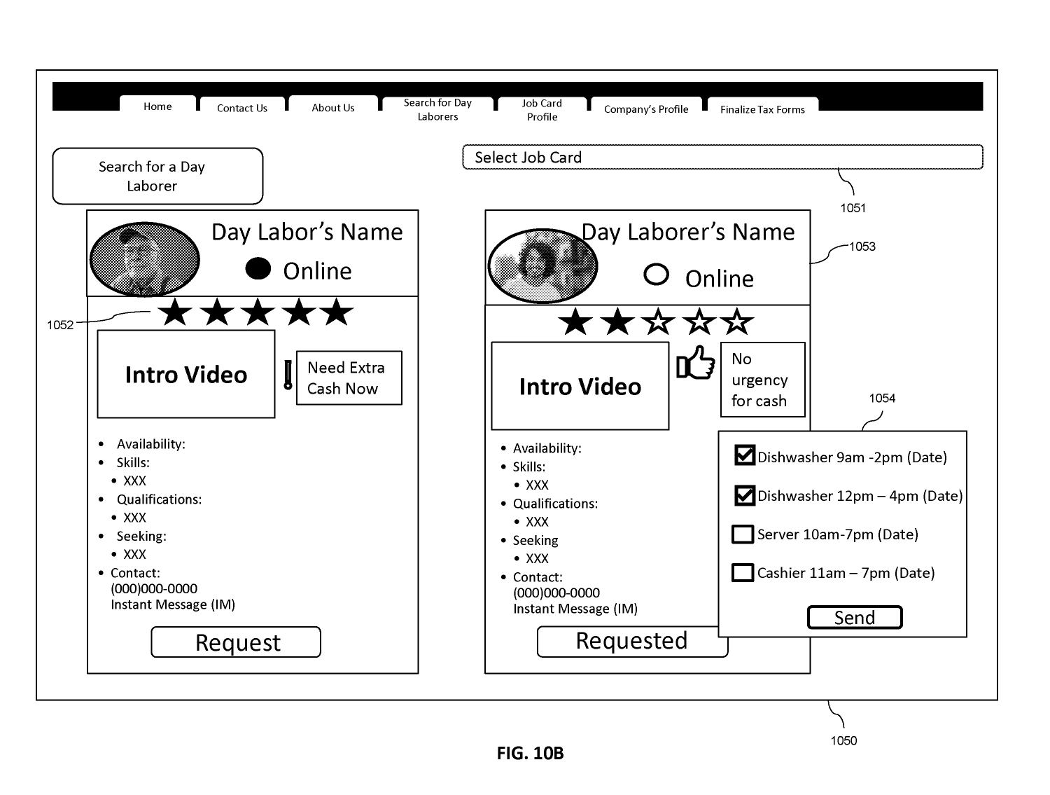

In some implementations, the job matching manager 150 can identify day laborers with the exact BLS SOC Code and specified experience level that align with the employer’s selected NAICS 6-digit code. The job matching manager 150 can determine that the day laborer’s job title, experience level, and industry code align with employer’s desired job title, desired experience level, and industry code, respectively, for precise matching (e.g., exact match 1001 in FIG. 10A).

In some implementations, the job matching manager 150 can perform an adaptive experience match to find candidates with varying experience levels (more, less, or equivalent) relative to the job posting, within the same industry and BLS SOC Code (e.g., adaptive experience match 1002 in FIG. 10A). The job matching manager 150 can evaluate relevance based on job roles and industry experience, adjusting for experience level differences.

In some implementations, the job matching manager 150 can perform a functional similarity match to identify candidates with job functions similar to those required, even if their BLS SOC Code or industry differs (e.g., functional similarity match 1003 in FIG. 10A). The job matching manager 150 can use a semantic analysis and Natural Language Processing (NLP) to identify closely related job titles or functions that align with the job posting.

In some implementations, the job matching manager 150 can perform a dreamer match to identify laborers whose aspirational job titles align with the employer’s job posting, assessing potential and aspirations of candidates, even if they lack direct experience (e.g., dreamer match 1004 in FIG. 10A).

For employers, the experience requirements can be categorized as "Expert Needed" (more than 5 years required), "Skilled Worker" (2-5 years required), "Entry-Level Welcome" (less than 2 years required), and "Dreamer Welcome" (no experience necessary). The job matching manager 150 can allow employers to specify the experience level needed for the job and select a code/title from the Bureau of Labor Statistics Standard Occupational Classification Codes and NAICS 6-digit code. The output for employers includes candidates sorted by exact matches first, followed by adaptive, functional, and dreamer matches.

For example, if an employer posts a job for a "Food Preparation Worker" in Full-Service Restaurants (NAICS Code 722511) with 2-5 years of experience, the exact match would be a laborer with "Food Preparation Worker" experience in Full-Service Restaurants (722511) and 2-5 years of experience. The adaptive experience match would be a laborer with "Food Preparation Worker" experience in Full-Service Restaurants (722511) with more or less experience. The functional similarity match would be a laborer with "Cook" experience with 2-5 years of experience in Limited-Service Restaurants (722513). The dreamer match would be a laborer who aspires to be a "Food Preparation Worker" but has no experience. The job matching manager 150 can ensure a broad, effective job-matching process by considering various levels of experience, job functions, and aspirations.

In some implementations, the tax calculating manager 170 can perform a dynamic tax lookup that takes into account the state and city where the work is being performed, the employee’s W-4 form data, and/or the hourly compensation offered by the employer. When an employer posts a job, the tax calculating manager 170 can capture the state and city where the work will be performed, and use this information to determine the appropriate state and local tax rates. The tax calculating manager 170 can integrate with a database or application programming interface (API) that provides up-to-date state and local tax rates, ensuring accurate tax calculations.

The W-4 form provides information regarding the employee’s tax filing status and the number of allowances claimed. This data can be used to calculate federal tax withholding and, in some cases, state-specific tax information. In some implementations, the tax calculating manager 170 can interpret the filing status, additional withholding amounts, and/or allowances when calculating federal and state income tax.

In some implementations, the tax calculating manager 170 can perform a calculation process involving several steps. In a first step, the tax calculating manager 170 can identify the employer’s location when the employer posts a job, specifying the state and city of the work site. The tax calculating manager 170 can reference this location to apply the correct state and local tax rates. Next, in some implementations, the tax calculating manager 170 can retrieve the W-4 information for the day laborer, including filing status, allowances, and any additional withholding. In some implementations, the tax calculating manager 170 can then reference a tax rate database or API that includes state and local tax rates for the employer’s location, allowing the system (e.g., employment system 100, tax calculating manager 170) to calculate state and local taxes based on where the work is performed.

In some implementations, the dynamic state and local tax calculation performed by the tax calculating manager 170 can begin by determining the employer’s location and fetching the state and city from the job posting. The tax calculating manager 170 can then look up state and local tax rates from the tax database or API. The tax calculating manager 170 can determine federal tax withholding using the W-4 form data and IRS tax tables. The tax calculating manager 170 can calculate state tax withholding using the state tax rate specific to the employer’s location, applying the appropriate percentage to the laborer’s gross income. Many states have graduated income tax rates, so the tax calculating manager 170 can apply the correct tax bracket based on income. If the employer’s location includes a city or county tax, the tax calculating manager 170 can calculate the local tax withholding based on the local tax rate. The tax calculating manager 170 can apply FICA withholding using the standard Social Security and Medicare percentages.

Gross income is calculated by multiplying the hourly wage by the hours worked. Net income is then determined by subtracting the federal, state, local, and Federal Insurance Contributions Act (FICA) withholdings from the gross income. For example, with an hourly wage of $20, 40 hours worked, and an employer location in New York City, the gross income would be $800. Federal tax withholding at 10% would be $80, state tax withholding at 6.5% would be $52, local tax withholding at 3.9% would be $31.2, Social Security withholding at 6.2% would be $49.6, and Medicare withholding at 1.45% would be $11.6. The net income would be $575.6 after subtracting these withholdings from the gross income.

To fully automate this process, the tax calculating manager 170 can integrate a tax lookup system, either using a third-party tax API to retrieve current state and local tax rates based on the employer’s location or maintaining a tax rate database within the tax calculating manager 170 that updates periodically to reflect changes in state and local tax policies. This ensures that when a day laborer works in a different state or city, the correct tax rates are applied. The tax calculating manager 170 can also display estimated net income to day laborers based on these tax calculations before they accept the job.

To help employers manage the W-2 process for day laborers in the employment system 100, the system (e.g., employment system 100, tax calculating manager 170) can simplify and automate W-2 form creation, tax calculations, and uploading. The system can support employers by streamlining tax data collection. When a day laborer accepts a job, the system can prompt the laborer to complete a digital W-4 form for employees or record their independent contractor status for 1099 forms. This ensures the necessary information is available for tax withholding and reporting purposes. For employees, the system can store their W-4 data, such as filing status and allowances, to calculate withholdings. For independent contractors, the system can generate 1099-NEC forms for end-of-year reporting, but no withholdings may be calculated upfront.

In some implementations, the tax calculating manager 170 can include a dynamic tax lookup system that pulls accurate state and local tax rates based on the employer’s location. When an employer posts a job, the tax calculating manager 170 can record the location where the work will take place. The tax calculating manager 170 can integrate with a third-party tax API, such as Avalara, TaxJar, or Vertex, to retrieve up-to-date tax rates based on location. Alternatively, the tax calculating manager 170 can maintain an internal tax database (e.g., in the databases 120) that is periodically updated to reflect current tax rates for all states and cities.

Once the system has the employer’s location and the day laborer’s W-4 data, the tax calculating manager 170 can calculate all applicable taxes. The calculation workflow involves several steps. First, the tax calculating manager 170 can calculate a gross income based on the hourly wage and hours worked. The tax calculating manager 170 can the calculate Federal tax withholding using W-4 data and IRS tax tables. The tax calculating manager 170 can determine State tax withholding using the state tax rate associated with the job location. If applicable, the tax calculating manager 170 can pull the local city or county tax rate based on the location and calculates the withholding. The tax calculating manager 170 can calculate FICA withholding for Social Security and Medicare. After taxes are deducted, the tax calculating manager 170 can show both gross income and net income to the employer and employee.

In some implementations, at the end of the year, the tax calculating manager 170 can assist employers with generating W-2 forms. Based on the data collected throughout the year, including tax withholdings, the tax calculating manager 170 can automatically generate W-2 forms for day laborers. Employers can preview W-2 forms before submission to ensure accuracy. The system (e.g., employment system 100, tax calculating manager 170) can offer two filing options: e-file, which enables employers to electronically file W-2 forms with the IRS and state tax agencies directly from the system, and download and upload, which allows employers to download completed W-2 forms in IRS-approved formats for manual upload to IRS systems or other payroll services.

In some implementations, the user interface manager 140 can provide a user-friendly interface that guides employers through the process of managing payroll taxes and generating W-2 forms. Employers can view all job postings and the tax-related details for each job, such as employee gross pay and tax withholdings, on a dashboard. The notification manager 180 can provide notifications to remind employers about tax deadlines, such as W-2 filing deadlines. A single button allows employers to generate W-2s for all employees who worked shifts during the year.

To help employers and laborers understand the pay breakdown during the job selection process, the tax calculating manager 170 can display gross income and estimated net income based on location-specific tax rates before the laborer accepts the job. This can transparency help both parties manage expectations and comply with tax obligations.

In some implementations, the tax calculating manager 170 can begin with the employer posting a job, capturing the location, and assigning the correct state and local tax rates. When a laborer accepts the job, they fill out a W-4 form or confirm independent contractor status. After the job is completed, the tax calculating manager 170 can calculate gross income and applies the correct federal, state, and local tax withholdings. The tax calculating manager 170 can receive a detailed pay slip showing gross and net income, along with all tax withholdings. At year-end, the tax calculating manager 170 can compile all the laborer’s earnings and tax withholdings and generates a W-2 form. Employers can review, electronically file, or download the W-2 for submission to the IRS.

In some implementations, the tax calculating manager 170 can ensure W-2 filing compliance by reminding employers (e.g., by the notification manager 180) of the January 31 deadline for distributing W-2 forms to employees and filing with the IRS. The tax calculating manager 170 can integrate with e-file services or directly with the IRS to allow seamless W-2 submission from the employment system 100. These features can enable the tax calculating manager 170 can provide employers with a comprehensive, automated solution for tax compliance and W-2 form management, simplifying what would otherwise be a complex process for day labor and employers.

In some implementations, the tax calculating manager 170 can handle multiple W-4 forms for a single day laborer by maintaining a history of all W-4 forms submitted throughout the year, with each form having an effective date indicating when it started being used for tax calculations. When a laborer applies for or completes a job shift, the tax calculating manager 170 can capture the W-4 information in effect at the time of job acceptance or shift completion and links the specific W-4 form to the job shift, ensuring that the withholding calculations reflect the correct form. For each shift worked, the tax calculating manager 170 can retrieve the applicable W-4 form and uses the data to calculate federal tax withholdings for that shift.

In some implementations, at year-end, when generating W-2 forms, the tax calculating manager 170 can aggregate earnings by W-4 form, ensuring that the earnings and withholdings reported on the W-2 form are based on the W-4 form data applicable at the time each shift was worked. The tax calculating manager 170 can combine all shifts worked, withholdings, and applicable W-4 forms into the final W-2 report.

In some implementations, the database 120 can store multiple W-4 forms per laborer with timestamps indicating when they were submitted, tracking job shifts with references to the applicable W-4 form used during each shift, and recording earnings and withholdings for each shift tied to the W-4 form in effect. The system (e.g., employment system 100 or tax calculating manager 170) can capture the effective W-4 form when a laborer accepts a job and using the captured W-4 form to calculate tax withholdings for that shift. During W-2 generation, the system can aggregate all shifts and associated W-4 forms to ensure correct totals and creates W-2 forms reflecting the correct tax information based on the W-4 form applicable to each shift.

In some implementations, the user interface manager 140 can allow day laborers to view and manage their W-4 forms within the employment system 100, providing a summary of each shift’s associated W-4 form for both employers and laborers, and generating reports showing tax withholdings and earnings based on the W-4 forms used. Testing and compliance involve testing the system with multiple W-4 submissions and varying job shifts to ensure accurate W-2 generation and ensuring the application (e.g., application running on a user device 150-1) can comply with IRS regulations for W-2 reporting and W-4 form handling.

By incorporating these features, the system (e.g., the employment system 100 or the tax calculating manager 170) can effectively handle multiple W-4 forms for day laborers and ensure that W-2 forms accurately reflect the appropriate tax information for each job shift worked

Various implementations in the present disclosure have one or more of the following advantages and benefits.

First, implementations in the present disclosure can streamline the onboarding/hiring process through a mobile application that stores and transfers documents to the employer seamlessly. In some implementations, the system can onboard (e.g., integrate, hire) day laborers by allowing the day laborers to electronically complete essential employment documents and create an introductory video, all within a mobile application.

Second, implementations in the present disclosure can perform an enhanced bidirectional job-matching process (e.g., job-matching method, job-matching algorithm) between users seeking jobs and available positions of employers.

Third, implementations in the present disclosure can perform a dynamic tax lookup and/or a dynamic tax calculation. For example, for a position/job/work of an employer, the system can determine the state and city where the work is being prepared (e.g., employer’s location). For a user (e.g., day laborer) seeking the position/job/work, the system can determine the employee’s W-4 form data, such as filing status and allowances, determine the hourly compensation offered to the user by the employer.

FIG. 2 is a block diagram illustrating an example of a computing system according to some implementations.

Referring to FIG. 2, the illustrated example computing system 172 includes one or more processors 210 in communication, via a communication system 240 (e.g., bus), with memory 260, at least one network interface controller 230 with network interface port for connection to a network (not shown), and other components, e.g., an input/output (“I/O”) components interface 450 connecting to a display (not illustrated) and an input device (not illustrated). Generally, the processor(s) 210 will execute instructions (or computer programs) received from memory. The processor(s) 210 illustrated incorporate, or are directly connected to, cache memory 220. In some instances, instructions are read from memory 260 into the cache memory 220 and executed by the processor(s) 210 from the cache memory 220.

In more detail, the processor(s) 210 may be any logic circuitry that processes instructions, e.g., instructions fetched from the memory 260 or cache 220. In some implementations, the processor(s) 210 are microprocessor units or special purpose processors. The computing device 200 may be based on any processor, or set of processors, capable of operating as described herein. The processor(s) 210 may be single core or multi-core processor(s). The processor(s) 210 may be multiple distinct processors.

The memory 260 may be any device suitable for storing computer readable data. The memory 260 may be a device with fixed storage or a device for reading removable storage media. Examples include all forms of non-volatile memory, media and memory devices, semiconductor memory devices (e.g., EPROM, EEPROM, SDRAM, and flash memory devices), magnetic disks, magneto optical disks, and optical discs (e.g., CD ROM, DVD-ROM, or Blu-Ray® discs). A computing system 172 may have any number of memory devices as the memory 260.

The cache memory 220 is generally a form of computer memory placed in close proximity to the processor(s) 210 for fast read times. In some implementations, the cache memory 220 is part of, or on the same chip as, the processor(s) 210. In some implementations, there are multiple levels of cache 220, e.g., L2 and L3 cache layers.

The network interface controller 230 manages data exchanges via the network interface (sometimes referred to as network interface ports). The network interface controller 230 handles the physical and data link layers of the OSI model for network communication. In some implementations, some of the network interface controller’s tasks are handled by one or more of the processor(s) 210. In some implementations, the network interface controller 230 is part of a processor 210. In some implementations, a computing system 172 has multiple network interfaces controlled by a single controller 230. In some implementations, a computing system 172 has multiple network interface controllers 230. In some implementations, each network interface is a connection point for a physical network link (e.g., a cat-5 Ethernet link). In some implementations, the network interface controller 230 supports wireless network connections and an interface port is a wireless (e.g., radio) receiver/transmitter (e.g., for any of the IEEE 802.11 protocols, near field communication “NFC”, Bluetooth, ANT, or any other wireless protocol). In some implementations, the network interface controller 230 implements one or more network protocols such as Ethernet. Generally, a computing device 172 exchanges data with other computing devices via physical or wireless links through a network interface. The network interface may link directly to another device or to another device via an intermediary device, e.g., a network device such as a hub, a bridge, a switch, or a router, connecting the computing device 172 to a data network such as the Internet.

The computing system 172 may include, or provide interfaces for, one or more input or output (“I/O”) devices 250. Input devices include, without limitation, keyboards, microphones, touch screens, foot pedals, sensors, MIDI devices, and pointing devices such as a mouse or trackball. Output devices include, without limitation, video displays, speakers, refreshable Braille terminal, lights, MIDI devices, and 2-D or 3-D printers.

Other components may include an I/O interface, external serial device ports, and any additional co-processors. For example, a computing system 172 may include an interface (e.g., a universal serial bus (USB) interface) for connecting input devices, output devices, or additional memory devices (e.g., portable flash drive or external media drive). In some implementations, a computing device 172 includes an additional device such as a co-processor, e.g., a math co-processor can assist the processor 210 with high precision or complex calculations.

FIGS. 3 to FIG. 9 are example user interfaces 300, 400, 500, 600, 700, 800, 900 for displaying and receiving employment information on a user device (e.g., a user device of a day laborer) according to some implementations. An employment platform (e.g., job matching platform) can use a job matching system to facilitate employment onboarding for job seekers (e.g., day laborers). The platform can enable users to electronically complete necessary employment forms (I-9, W-4), upload supporting documentation, and create a video (e.g., a 30-second introductory video). These documents and data can be transmitted to employers when the day laborer is hired for a shift. The platform can simplify the hiring process for both laborers and employers.

FIG. 3 is an example user interface 300 for logging into an employment platform according to some implementations. The user interface 300 can show a home page or a landing page of the employment platform (e.g., an employment system 100). In response to clicking a home button 310, the employment system (e.g., the user interface manager 140) can display the user interface 300. The user interface 300 can include a sign-in button 320, a sign-in button 330, a sign-in button 340 and/or a sign-in button 350 for an existing employer (who already has an account in the system), a new employer, an existing day laborer (who already has an account in the system), and/or a new day laborer, respectively. The employment system 100 can show the user interfaces 300, 400, 500, 600, 700, 800, 900, when a day laborer user logs into the system (e.g., by clicking the button 320 or 340 in FIG. 3). The employment system 100 can show the user interfaces 1000, 1050, 1100, 1200, 1300, 1400, when an employer user logs into the system (e.g., by clicking the button 320 in FIG. 3).

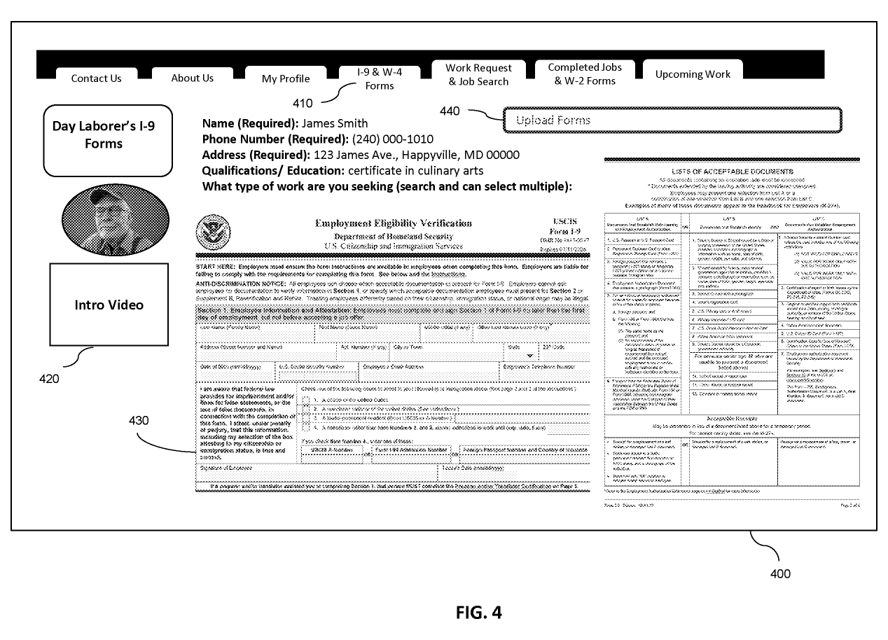

FIG. 4 is an example user interface 400 for uploading forms and/or documents for employment of a user (e.g., a day laborer), according to some implementations. The day laborer can upload an introductory video 420. The day labor cannot search for work until W-4 and I-9 Form and supporting documents is submitted by selecting the menu 410. For example, each time the I-9 form 430 is edited the prior version can be saved as a PDF with the supporting documentation that was provided. The day laborer can upload forms (e.g., I-9 or W-4) and/or documents using an upload interface or button 440.

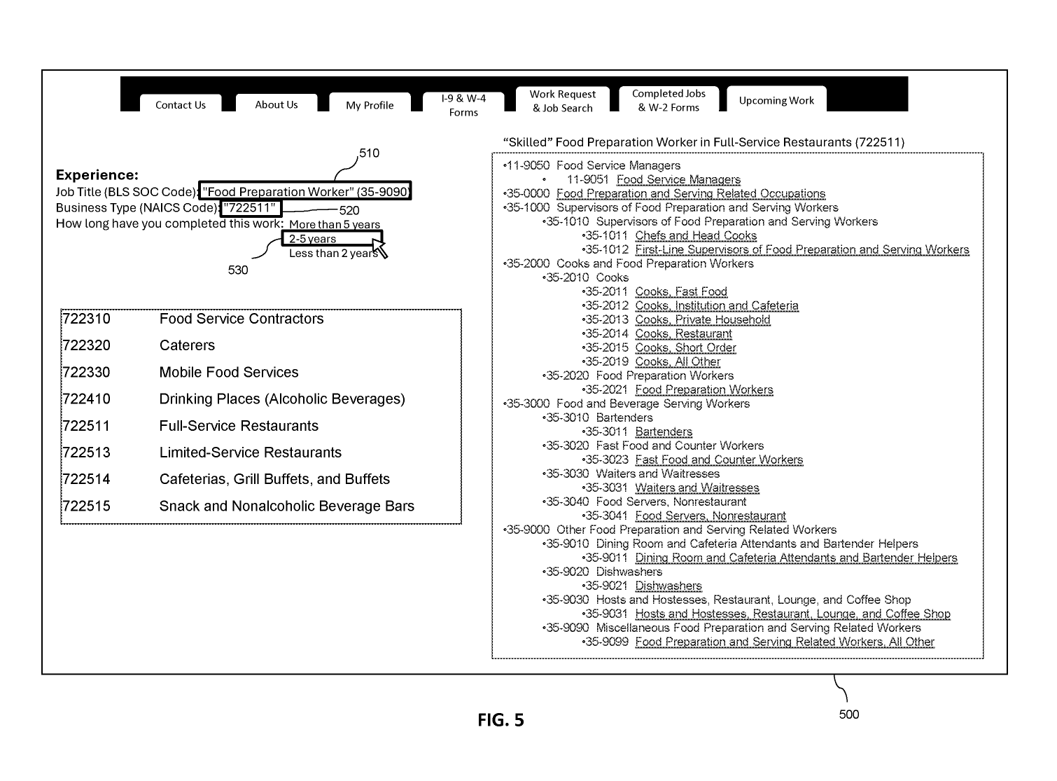

FIG. 5 is an example user interface for a day laborer to enter title 510 and type 520 of desired jobs (e.g., desired positions of employers) and the experience level 530 of the day laborer, according to some implementations.

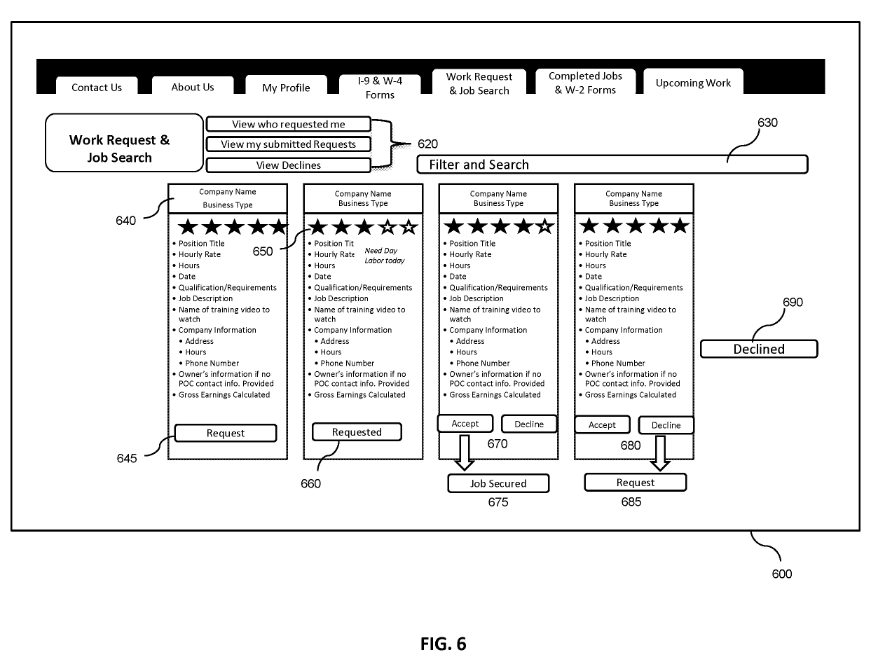

FIG. 6 is an example user interface 600 for searching for desired jobs (e.g., desired positions of employers), according to some implementations. Referring to FIG. 6, the user interface 600 can allow the day laborer to request a work and/or search for a job. The view buttons 620 can allow the day laborer to view who requested the day laborer, view the requests submitted by the day laborer, and/or view declines received by the day laborer. The filter and search input 630 can filter all fields in the job card. For example, from the “address” field, the day laborer can filter by mile radius from employers’ address or zip code and overlap their availability. In addition to seeing where they are, the user interface manager 140 can allow the day laborer to perform an open search by providing buttons for exact match, adaptive experience, functional similarity match, and/or dreamer match (not shown). The job card profile 640 can be a link such that once the day laborer clicks on the link, the user interface 600 can open a job card profile of an employer (e.g., company) where the day laborer can see all available job cards for that company. The request button 645 can allow the day laborer to request a job and change this button to “requested” status (e.g., the “requested” status as shown in the request status 660). The rating of the employer 650 can indicate an aggregate of all reviews day laborers have given the employer. The request status 660 can allow the day laborer to double click the request status 660 to cancel the request and put the request status back in “request” status. The accept/decline button 670, 680 can be only display if an employer has requested that day laborer. Once the day laborer has accepted the request, the status can change to “job secured” as shown in the job offer status 675 and then the day laborer can be prompt to give access to profile, I-9 and W-4 form within an hour of shift starting. Once the day laborer has declined the request, the status can revert to “request” as shown in the job offer status 685. The “Declined” status (in the job offer status 690) can be only shown for the day laborer if the position has been filled by another day laborer.

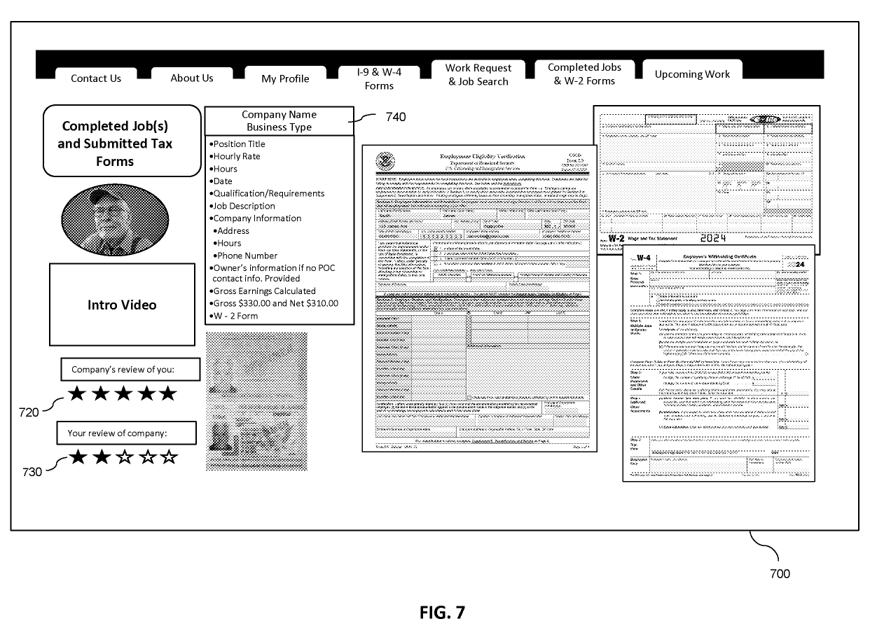

FIG. 7 is an example user interface 700 for displaying one or more jobs completed by a day laborer and documentation on the day laborer, according to some implementations. The user interface 700 can include one or more jobs (of an employer) 740, a rating of the day laborer 720 (e.g., 5-star rating), and/or a rating of the employers 730. The user interface 700 can display one or more jobs 740 completed by the day laborer and his or her all finalized tax forms. The completed job information 740 can indicate all jobs the day laborer has completed with this employer. The rating of the day laborer 720 can indicate an aggregate of all reviews the employer has given to the day laborer. The review (or rating) of the employer 730 can indicate an aggregate of all reviews the day laborer has given to the employer. If the day laborer completes multiple jobs for the same employer, the user interface 700 can show all completed job cards.

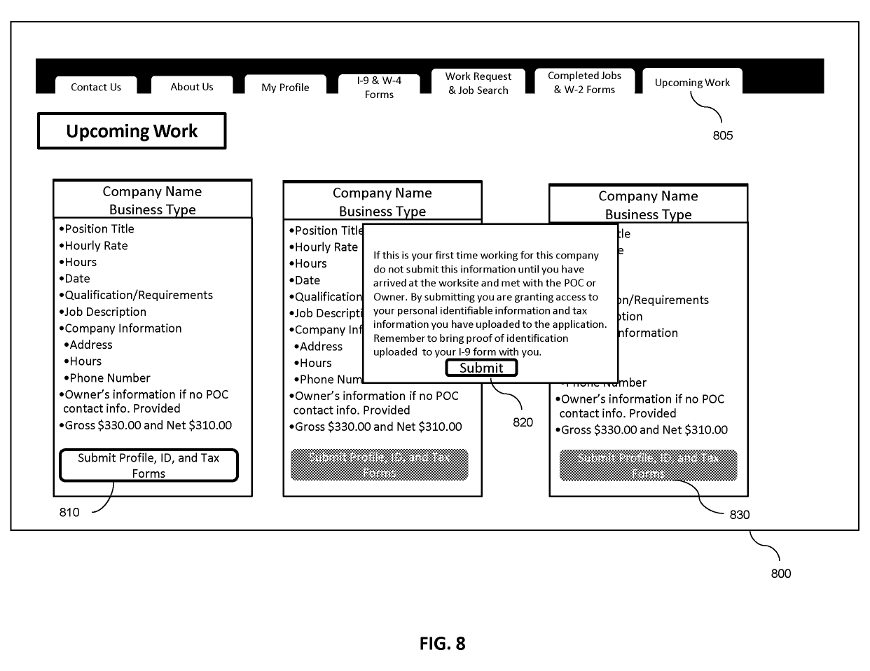

FIG. 8 is an example user interface 800 for displaying one or more upcoming jobs or works assigned to a day laborer, according to some implementations. Upon selecting the upcoming work, the day laborer can see a list of one or more upcoming jobs or works assigned to the day laborer. The button 810 can allow the day laborer to submit a profile, ID and tax forms of the day laborer. In some implementations, the button 810 can blink red until the day laborer submits such information. Once the day laborer clicks this button 810, a pop-up window including the submit button 820 can be shown. The button 830 can be grayed out until it is within an hour they are due to work. In other words, they cannot be submitted until they are blinking red.

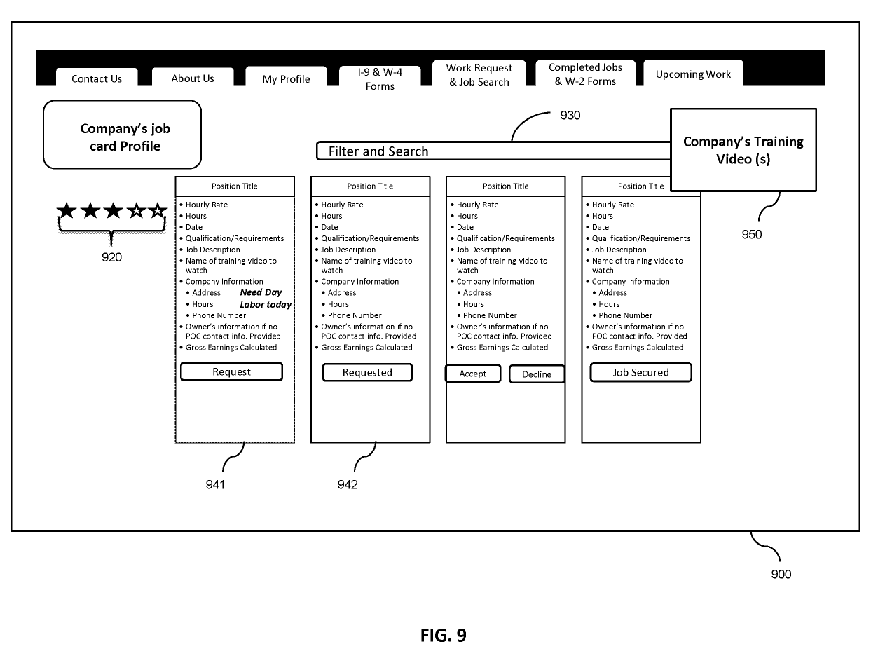

FIG. 9 is an example user interface 900 for displaying information of an employer (e.g., company profile) and one or more jobs posted by the employer (e.g., job card profile), according to some implementations. The user interface 900 can include a review or rating of an employer 920 (e.g., 5-star rating) and/or a filter and search input 930. The user interface 900 can allow a day laborer to access a job card profile of an employer including one or more job cards 941, 942, for example. The rating of the employer 920 can indicate an aggregate of all reviews left by day laborers. The filter and search input 930 can allow the day laborer to filter fields of a job card and search for a job. In the user interface 900, day labors can only view all jobs the employer has posted, watch the employer’s training videos 950, and submit, accept, or decline request.

FIGS. 10A and FIG. 10B is example user interfaces 1000 and 1050 for searching for a day laborer, according to some implementations. The user interface 1000 can include search options for an employer to search for day laborers. Buttons for the search options can include an exact match button 1001, an adaptive experience match button 1002, a functional similarity match button 503, and/or a dreamer match 1004. For example, when the exact match button 1001 is selected, the user interface 1000 can show input interfaces to input a desired job title 1010, a desired job type 1020, and/or a desired experience level 1030.

The user interface 1050 can include a rating 1052 (e.g., 5-star rating), a job card selection input 1051, a day laborer profile 1053, and/or a job positions box 1054. In some implementations, there can be two ways to perform a search for day laborers: selective search and open search. The job card selection input 1051 can allow an employer to perform a selective search. After the employer has created job card(s), the employer can use the job card selection input 1051to select a job card they would like to search for available day laborers. The user interface 1050 can align the availability of a day laborer and the date and hours on the job card, and then allow the employer to select the day laborer (e.g., by clicking the “request” button). The job positions box 1054 can only pop-up after the employer has selected “request”. Only job cards that align with the day laborer’s availability can be shown in the box 1054. After the employer selects at least one position from the box 1054, the employer can click the “send” button, and then the day laborer can receive a notification of the request. The status of the day laborer profile 1053 can then change to “requested”.

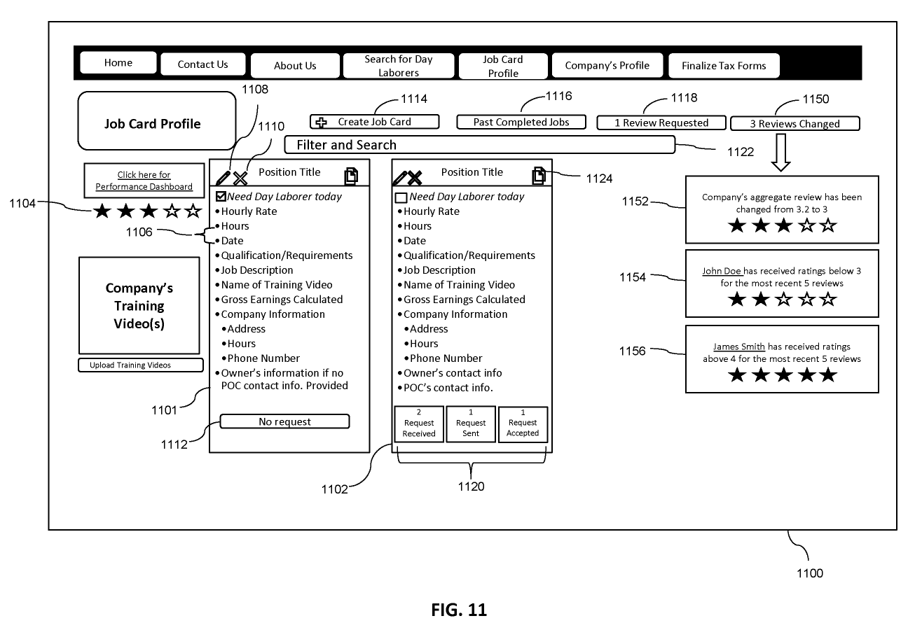

FIG. 11 is an example user interface 1100 for creating a job card (e.g., job card profile, job announcement, job post, recruiting card, recruiting announcement, recruiting post) by an employer, according to some implementations. The user interface 1100 can include a job card 1101, a job card 1102, a review or a rating 1104 (e.g., 5-star rating), a date/time 1106, an edit button 1108, a delete button 1110, a job card status 1112, a create job card button 1114, a past completed jobs button 1116, a number of reviews requested 1118, a job card status 1120, a search input 1122, a copy button 1124, a number of reviews changed button 1150, a rating (review) change notification 1152, a rating (review) change notification 1154, and/or a rating (review) change notification 1156.

Referring to FIG. 11, when an employer (e.g., company) has signed in the system, the user interface 1100 can display a job card profile of the employer including information on one or more job cards posted by the employer (e.g., the job cards 1101, 1102). The rating 1104 indicates an aggregate of all reviews (ratings) day laborers have given the employer. When the employer clicks the create job card button 1114, the user interface 1100 can allow the employer to select multiple dates and time slots (e.g., dates/hours 1106) for a new job card (e.g., new job post). In response to selecting dates and time slots, the system can create a new job card for each new time slot or date selected. For each job card, the edit button 1108 can allow the employer to edit the job card until a request (e.g., request for job application or job offer) has been received (e.g., from one or more day laborers) or sent (e.g., to one or more day laborers). After a request is sent or received the job card can be locked. The delete button 1110 can allow the employer to delete the job card only until a job has been secured and/or a day laborer has been hired. The job card status 1112 can indicate “No request” as a default text until at least one request is sent by an employer or received by a day laborer. Once the create job card button 1114 is clicked, a new job card can pop-up and only fields that are classified as 1 can be edited. The past completed jobs button 1116 can allow the employer to view past completed jobs (as a default filter view). The number of reviews requested 1118, once clicked, can take the employer to a page of the reviews requested, on which the employer can leave a review of all day laborers who have completed work. The job card status 1120 can include boxes indicating the number of requests received, the number of request sent, and/or the number of request accepted. These boxes can only show after at least one request has been received or sent. By clicking on any of these boxes, the employer can see one or more requests received from day laborers, one or more requests the employer has sent, and one or more day laborers who secured the job. The search input 1122 can filter all fields in the job card. The copy button 1124 can allow the employer to duplicate a job card and only change date and/or hours.

The number of reviews changed button 1150 can allow the employer to see notifications (e.g., messages) relating to review changes. When the employer clicks the number of reviews changed button 1150, the user interface 1100 can display (1) the rating (review) change notification 1152 that the employer’s aggregate review has been changed from 3.2 to 3; (2) the rating (review) change notification 1154 that the day laborer John Doe has received ratings below 3 for recent 5 reviews; and/or (3) the rating (review) change notification 1156 that the day laborer James Smith has received ratings above 4 for recent 5 reviews.

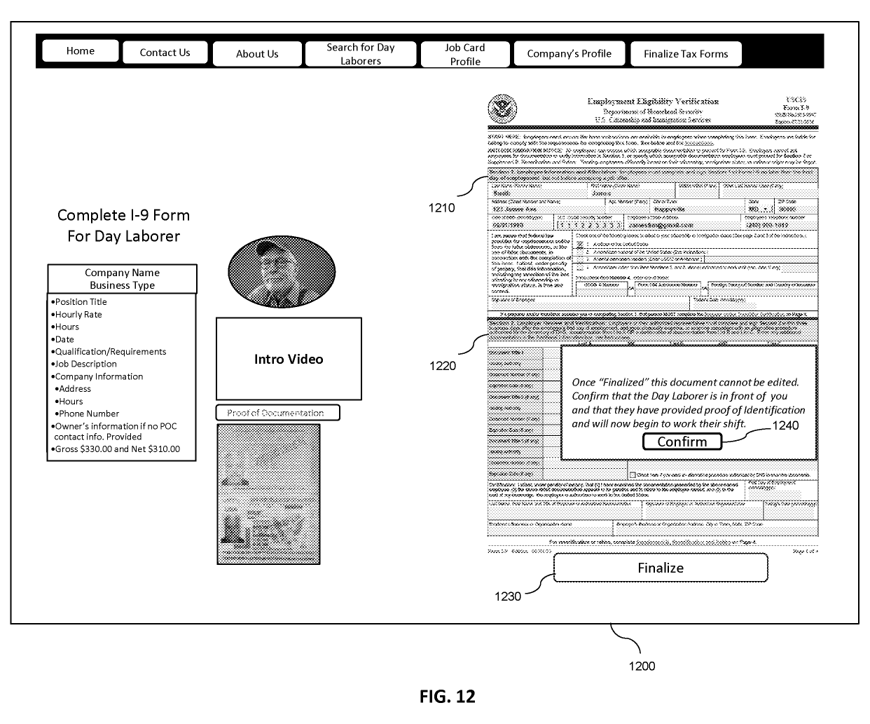

FIG. 12 is an example user interface 1200 for finalizing a tax form (including multiple sections 1210, 1220) for a day laborer to begin to work on one or more jobs, according to some implementations. Once the employer clicks a finalize button 1230, a pop-up window can ask the employer to confirm via a confirm button 1240. Once the confirm button 1240 is clicked, the document can be saved as a PDF and PDF is attached/linked to a job card.

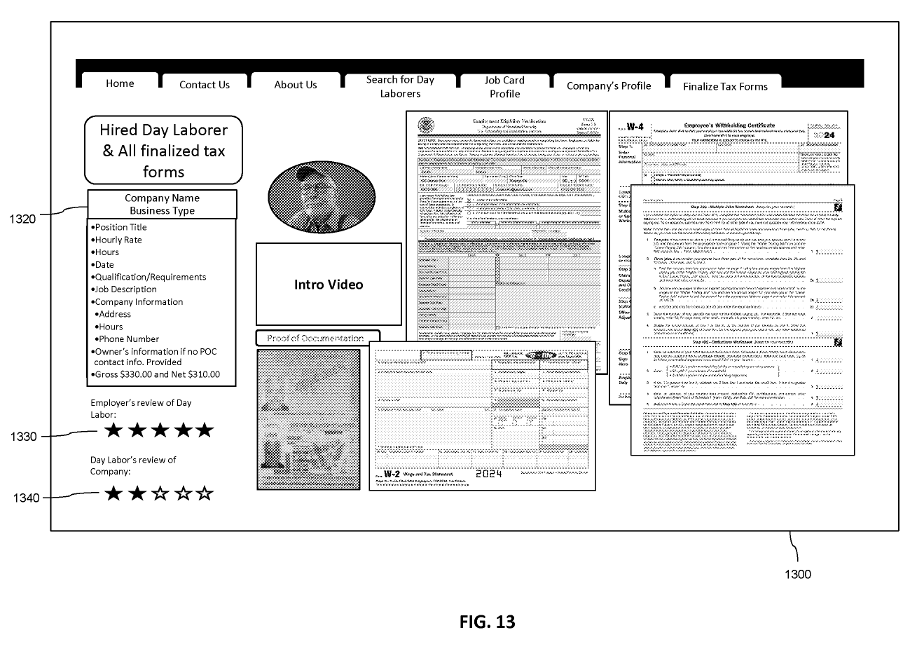

FIG. 13 is an example user interface 1300 for displaying information of a hired day laborer, according to some implementations. The user interface 1300 can include completed job information 1320, a rating of the hired day laborer 1330 (e.g., 5-star rating), and/or a rating of the employer 1340. The user interface 1300 can display information of the hired day laborer and his or her all finalized tax forms. The completed job information 1320 can indicate all jobs the day laborer has completed with this employer. The rating of the hired day laborer 1330 can indicate the employer’s review of the day labor which is an aggregate of all reviews the employer has given to the day laborer. The review (or rating) of the employer can indicate an aggregate of all reviews the day laborer has given to the employer.

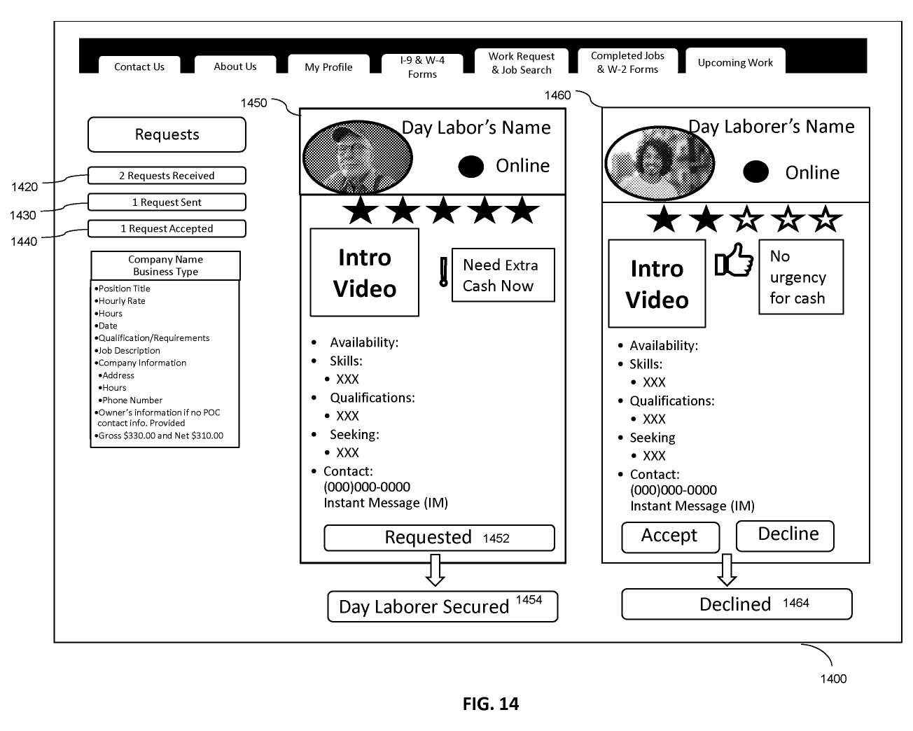

FIG. 14 is an example user interface 1400 for displaying one or more work requests sent by an employer to one or more day laborers or one or more work requests sent by one or more day laborers to the employer, according to some implementations. The user interface 1400 can include status buttons 1420, 1430, 1440 which allows the employer to see the number of requests received from day laborers, the number of requests sent by the employer, and the number of requests accepted by day laborers, respectively. For example, the employer sent a request to a day laborer, the request 1450 can be shown and the status can reflect “Requested” 1452. If the day laborer accepts the employer’s request the status is changed to “Day Laborer Secured” 1454. In some implementations, only one request can be accepted. If a request is submitted by the employer, the first day laborer who accept the request can get the job, or if a request is submitted by a day laborer and the employer who accepts that day laborer gets the day laborer. The system can prevent anyone else form accepting a request. In some implementations, there can be accept and decline buttons for all requests the employer has received. Once one request is accepted (not shown), all other request received and sent (e.g., request 1460) can be automatically declined 1464, and a notification can be sent to day laborers notifying them of the decline. In some implementations, an employer can only receive five requests and send five requests. Once the ten limit is reached the system may not allow any more request to be received or sent until some have been declined.

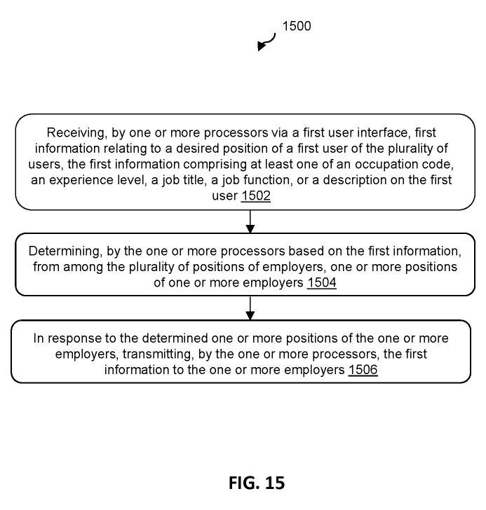

FIG. 15 is a flowchart illustrating an example methodology for matching between users seeking employment and positions of employers, according to some implementations. In this example methodology, a process 1500 begins at step 1502 by receiving, by one or more processors (e.g., one or more processors 210 of employment system 100), via a first user interface (e.g., user interface 500), first information relating to a desired position of a first user of the plurality of users (e.g., day laborers), the first information including at least one of an occupation code (e.g., NAICS code 520), an experience level (e.g., 2-5 years 530), a job title (e.g., food preparation worker 510), a job function, or a description on the first user.

At step 1504, in some implementations, the one or more processors may be configured to determine, based on the first information, from among the plurality of positions of employers, one or more positions of one or more employers (e.g., user interface 600).

At step 1506, in some implementations, in response to the determined one or more positions of the one or more employers, the one or more processors may be configured to transmit the first information to the first user (e.g., user interface 600). For example, the request button 645 can allow the day laborer to request a job and change this button to “requested” status (e.g., the “requested” status as shown in the request status 660).

In some implementations, in determining the one or more positions of the one or more employers, the one or more processors may determine that the first information includes the occupation code, the experience level, and the job title. The one or more processors may identify second information relating to each of the plurality of positions, the second information including an industry code, an experience level, and a job title. The one or more processors may determine that the occupation code, the experience level and the job title of the first user align with the industry code, the experience level and the job title of a first position of the one or more positions, respectively.

In some implementations, in determining the one or more positions of the one or more employers, the one or more processors may determine that the first information includes the occupation code and the experience level. The one or more processors may identify second information relating to each of the plurality of positions, the second information including an industry code and an experience level. The one or more processors may determine that the occupation code of the first user aligns with the industry code of a second position of the plurality of positions. The one or more processors may determine, based on the industry code, a range of the experience level of the second position. The one or more processors may determine that the experience level of the first user falls within the range of the experience level of the second position.

In some implementations, in determining the one or more positions of the one or more employers, the one or more processors may determine that the first information includes the occupation code, the job title, and the job function. The one or more processors may identify second information relating to each of the plurality of positions, the second information including an industry code, a job title and a job description. The one or more processors may determine that the occupation code of the first user is different from the industry code of a third position of the plurality of positions. The one or more processors may perform a semantic analysis and a natural language processing (NLP) on (1) the occupation code, the job title, and the job function of the first user and (2) the industry code and the job description of the third position. The one or more processors may determine, based on a result of the semantic analysis and the NLP, a degree of similarity between (1) the occupation code, the job title, and the job function of the first user and (2) the industry code and the job description of the third position. The one or more processors may determine that the degree of similarity is greater than a first threshold.

In some implementations, in determining the one or more positions of the one or more employers, the one or more processors may determine that the first information includes the occupation code, the experience level, the job title and the description on the first user. The one or more processors may identify second information relating to each of the plurality of positions, the second information including an industry code, a job title and a job description. The one or more processors may determine that the experience level of the first user corresponds to no experience. The one or more processors may determine that the occupation code and the job title of the first user align with the industry code and the job title of a fourth position of the one or more positions, respectively. The one or more processors may perform a semantic analysis and a natural language processing (NLP) on (1) the description on the first user and (2) the job description of the third position. The one or more processors may determine, based on a result of the semantic analysis and the NLP, a degree of similarity between (1) the description on the first user and (2) the job description of the third position. The one or more processors may determine that the degree of similarity is greater than a second threshold.

In some implementations, the one or more processors may receive, via a second user interface (e.g., user interface 1000), position information relating to a particular position of the plurality of positions of employers, the position information including at least one of an industry code (e.g., NAICS code 1020), an experience level (e.g., 2-5 years 1030), and a job title (e.g., “food preparation worker” 1010), or a job description on the particular position. The one or more processors may determine, based on the position information, from among the plurality of users, one or more users. In response to the determined one or more users, the one or more processors may send a notification to an employer (who has entered the position information) about the determined one or more users (e.g., user interface 1050).

In some implementations, in determining the one or more users, the one or more processors may determine that the position information includes the industry code, the experience level, and the job title. The one or more processors may identify candidate information relating to each of the plurality of users, the candidate information including an occupation code, an experience level and a job title. The one or more processors may determine that the industry code, the experience level and the job title of the particular position align with the occupation code, the experience level and the job title of a second user of the plurality of users, respectively. For example, the job matching manager 150 can identify day laborers with the exact BLS SOC Code and specified experience level that align with the employer’s selected NAICS 6-digit code. The job matching manager 150 can determine that the day laborer’s job title, experience level, and industry code align with employer’s desired job title, desired experience level, and industry code, respectively, for precise matching (e.g., exact match 1001 in FIG. 10A).

In some implementations, in determining the one or more users, the one or more processors may determine that the position information includes the industry code and the experience level. The one or more processors may identify candidate information relating to each of the plurality of users, the candidate information including an occupation code and an experience level. The one or more processors may determine that the occupation code of a third user of the plurality of users aligns with the industry code of the particular position. The one or more processors may determine, based on the industry code of the position information, a range of the experience level of the particular position. The one or more processors may determine that the experience level of the second user falls within the range of the experience level of the particular position. For example, the job matching manager 150 can perform an adaptive experience match to find candidates with varying experience levels (more, less, or equivalent) relative to the job posting, within the same industry and BLS SOC Code (e.g., adaptive experience match 1002 in FIG. 10A). The job matching manager 150 can evaluate relevance based on job roles and industry experience, adjusting for experience level differences.

In some implementations, in determining the one or more users, the one or more processors may determine that the position information includes the industry code, the job title, and the job description. The one or more processors may identify candidate information relating to each of the plurality of users, the candidate information including an occupation code, a job title and a job function. The one or more processors may determine that the occupation code of a fourth user of the plurality of users is different from the industry code of the particular position. The one or more processors may perform a semantic analysis and a natural language processing (NLP) on (1) the occupation code, the job title, and the job function of the fourth user and (2) the industry code and the job description of the particular position. The one or more processors may determine, based on a result of the semantic analysis and the NLP, a degree of similarity between (1) the occupation code, the job title, and the job function of the fourth user and (2) the industry code and the job description of the particular position. The one or more processors may determine that the degree of similarity is greater than a third threshold. For example, the job matching manager 150 can perform a functional similarity match to identify candidates with job functions similar to those required, even if their BLS SOC Code or industry differs (e.g., functional similarity match 1003 in FIG. 10A). The job matching manager 150 can use a semantic analysis and Natural Language Processing (NLP) to identify closely related job titles or functions that align with the job posting.

In some implementations, in determining the one or more users, the one or more processors may determine that the position information includes the industry code, the experience level, the job title and the job description. The one or more processors may identify candidate information relating to each of the plurality of users, the candidate information including an occupation code, a job title and a description on each user. The one or more processors may determine that the experience level of a fifth user of the plurality of users corresponds to no experience. The one or more processors may determine that the occupation code and the job title of the fifth user align with the industry code and the job title of the particular position, respectively. The one or more processors may perform a semantic analysis and a natural language processing (NLP) on (1) the description on the fifth user and (2) the job description of the particular position. The one or more processors may determine, based on a result of the semantic analysis and the NLP, a degree of similarity between (1) the description on the fifth user and (2) the job description of the particular position. The one or more processors may determine that the degree of similarity is greater than a fourth threshold. For example, the job matching manager 150 can perform a dreamer match to identify laborers whose aspirational job titles align with the employer’s job posting, assessing potential and aspirations of candidates, even if they lack direct experience (e.g., dreamer match 1004 in FIG. 10A).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean "one and only one" unless specifically so stated, but rather "one or more.” Unless specifically stated otherwise, the term "some" refers to one or more. All structural and functional equivalents to the elements of the various aspects described throughout the previous description that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase "means for."

It is understood that the specific order or hierarchy of blocks in the processes disclosed is an example of illustrative approaches. Based upon design preferences, it is understood that the specific order or hierarchy of blocks in the processes may be rearranged while remaining within the scope of the previous description. The accompanying method claims present elements of the various blocks in a sample order, and are not meant to be limited to the specific order or hierarchy presented.

The previous description of the disclosed implementations is provided to enable any person skilled in the art to make or use the disclosed subject matter. Various modifications to these implementations will be readily apparent to those skilled in the art, and the generic principles defined herein may be applied to other implementations without departing from the spirit or scope of the previous description. Thus, the previous description is not intended to be limited to the implementations shown herein but is to be accorded the widest scope consistent with the principles and novel features disclosed herein.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example.

The foregoing method descriptions and the process flow diagrams are provided merely as illustrative examples and are not intended to require or imply that the blocks of various examples must be performed in the order presented. As will be appreciated by one of skill in the art the order of blocks in the foregoing examples may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the examples disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the examples disclosed herein may be implemented or performed with a general purpose processor, a DSP, an ASIC, an FPGA or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In some examples, the functions described may be implemented in hardware, software, firmware, or any combination thereof. If implemented in software, the functions may be stored as one or more instructions or code on a non-transitory computer-readable storage medium or non-transitory processor-readable storage medium. The blocks of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed examples is provided to enable any person skilled in the art to make or use the present disclosure. Various modifications to these examples will be readily apparent to those skilled in the art, and the generic principles defined herein may be applied to some examples without departing from the spirit or scope of the disclosure. Thus, the present disclosure is not intended to be limited to the examples shown herein but is to be accorded the widest scope consistent with the following claims and the principles and novel features disclosed herein.

What is claimed is:

1. A system for matching between a plurality of users seeking employment and a plurality of positions of employers, comprising:
one or more processors and memory,
wherein the one or more processors are configured to;
receive, via a first user interface, first information relating to a desired position of a first user of the plurality of users, the first information comprising at least one of an occupation code, an experience level, a job title, a job function, or a description on the first user;
determine, based on the first information, from among the plurality of positions of employers, one or more positions of one or more employers; and
in response to the determined one or more positions of the one or more employers, transmit the first information to the first user.

2. The system according to claim 1, wherein in determining the one or more positions of the one or more employers, the one or more processors are configured to:
determine that the first information comprises the occupation code, the experience level, and the job title;
identify second information relating to each of the plurality of positions, the second information comprising an industry code, an experience level, and a job title; and
determine that the occupation code, the experience level and the job title of the first user align with the industry code, the experience level and the job title of a first position of the one or more positions, respectively.

3. The system according to claim 1, wherein in determining the one or more positions of the one or more employers, the one or more processors are configured to:
determine that the first information comprises the occupation code and the experience level;
identify second information relating to each of the plurality of positions, the second information comprising an industry code and an experience level;
determine that the occupation code of the first user aligns with the industry code of a second position of the plurality of positions;
determine, based on the industry code, a range of the experience level of the second position; and
determine that the experience level of the first user falls within the range of the experience level of the second position.

4. The system according to claim 1, wherein in determining the one or more positions of the one or more employers, the one or more processors are configured to:
determine that the first information comprises the occupation code, the job title, and the job function;
identify second information relating to each of the plurality of positions, the second information comprising an industry code, a job title and a job description;
determine that the occupation code of the first user is different from the industry code of a third position of the plurality of positions;
perform a semantic analysis and a natural language processing (NLP) on (1) the occupation code, the job title, and the job function of the first user and (2) the industry code and the job description of the third position;
determine, based on a result of the semantic analysis and the NLP, a degree of similarity between (1) the occupation code, the job title, and the job function of the first user and (2) the industry code and the job description of the third position; and
determine that the degree of similarity is greater than a first threshold.

5. The system according to claim 1, wherein in determining the one or more positions of the one or more employers, the one or more processors are configured to:
determine that the first information comprises the occupation code, the experience level, the job title and the description on the first user;
identify second information relating to each of the plurality of positions, the second information comprising an industry code, a job title and a job description;
determine that the experience level of the first user corresponds to no experience;
determine that the occupation code and the job title of the first user align with the industry code and the job title of a fourth position of the one or more positions, respectively;
perform a semantic analysis and a natural language processing (NLP) on (1) the description on the first user and (2) the job description of the third position;
determine, based on a result of the semantic analysis and the NLP, a degree of similarity between (1) the description on the first user and (2) the job description of the third position; and
determine that the degree of similarity is greater than a second threshold.

6. The system according to claim 1, wherein the one or more processors are configured to:
receive, via a second user interface, position information relating to a particular position of the plurality of positions of employers, the position information comprising at least one of an industry code, an experience level, and a job title, or a job description on the particular position;
determine, based on the position information, from among the plurality of users, one or more users; and
in response to the determined one or more users, send a notification to an employer about the determined one or more users.

7. The system according to claim 1, wherein in determining the one or more users, the one or more processors are configured to:
determine that the position information comprises the industry code, the experience level, and the job title;
identify candidate information relating to each of the plurality of users, the candidate information comprising an occupation code, an experience level and a job title; and
determine that the industry code, the experience level and the job title of the particular position align with the occupation code, the experience level and the job title of a second user of the plurality of users, respectively.

8. The system according to claim 1, wherein in determining the one or more users, the one or more processors are configured to:
determine that the position information comprises the industry code and the experience level;
identify candidate information relating to each of the plurality of users, the candidate information comprising an occupation code and an experience level;
determine that the occupation code of a third user of the plurality of users aligns with the industry code of the particular position;
determine, based on the industry code of the position information, a range of the experience level of the particular position; and
determine that the experience level of the second user falls within the range of the experience level of the particular position.

9. The system according to claim 1, wherein in determining the one or more users, the one or more processors are configured to:
determine that the position information comprises the industry code, the job title, and the job description;
identify candidate information relating to each of the plurality of users, the candidate information comprising an occupation code, a job title and a job function;
determine that the occupation code of a fourth user of the plurality of users is different from the industry code of the particular position;
perform a semantic analysis and a natural language processing (NLP) on (1) the occupation code, the job title, and the job function of the fourth user and (2) the industry code and the job description of the particular position;
determine, based on a result of the semantic analysis and the NLP, a degree of similarity between (1) the occupation code, the job title, and the job function of the fourth user and (2) the industry code and the job description of the particular position; and
determine that the degree of similarity is greater than a third threshold.

10. The system according to claim 1, wherein in determining the one or more users, the one or more processors are configured to:
determine that the position information comprises the industry code, the experience level, the job title and the job description;
identify candidate information relating to each of the plurality of users, the candidate information comprising an occupation code, a job title and a description on each user;
determine that the experience level of a fifth user of the plurality of users corresponds to no experience;
determine that the occupation code and the job title of the fifth user align with the industry code and the job title of the particular position, respectively;
perform a semantic analysis and a natural language processing (NLP) on (1) the description on the fifth user and (2) the job description of the particular position;
determine, based on a result of the semantic analysis and the NLP, a degree of similarity between (1) the description on the fifth user and (2) the job description of the particular position; and
determine that the degree of similarity is greater than a fourth threshold.

11. A method for matching between a plurality of users seeking employment and a plurality of positions of employers, comprising:
receiving, by one or more processors via a first user interface, first information relating to a desired position of a first user of the plurality of users, the first information comprising at least one of an occupation code, an experience level, a job title, a job function, or a description on the first user;
determining, by the one or more processors based on the first information, from among the plurality of positions of employers, one or more positions of one or more employers; and
in response to the determined one or more positions of the one or more employers, transmitting, by the one or more processors, the first information to the first user.

12. The method according to claim 11, wherein determining the one or more positions of the one or more employers comprises:
determining that the first information comprises the occupation code, the experience level, and the job title;
identifying second information relating to each of the plurality of positions, the second information comprising an industry code, an experience level, and a job title; and
determining that the occupation code, the experience level and the job title of the first user align with the industry code, the experience level and the job title of a first position of the one or more positions, respectively.

13. The method according to claim 11, wherein determining the one or more positions of the one or more employers comprises:
determining that the first information comprises the occupation code and the experience level;
identifying second information relating to each of the plurality of positions, the second information comprising an industry code and an experience level;
determining that the occupation code of the first user aligns with the industry code of a second position of the plurality of positions;
determining, based on the industry code, a range of the experience level of the second position; and
determining that the experience level of the first user falls within the range of the experience level of the second position.

14. The method according to claim 11, wherein determining the one or more positions of the one or more employers comprises:
determining that the first information comprises the occupation code, the job title, and the job function;
identifying second information relating to each of the plurality of positions, the second information comprising an industry code, a job title and a job description;
determining that the occupation code of the first user is different from the industry code of a third position of the plurality of positions;
performing a semantic analysis and a natural language processing (NLP) on (1) the occupation code, the job title, and the job function of the first user and (2) the industry code and the job description of the third position;
determining, based on a result of the semantic analysis and the NLP, a degree of similarity between (1) the occupation code, the job title, and the job function of the first user and (2) the industry code and the job description of the third position; and
determining that the degree of similarity is greater than a first threshold.

15. The method according to claim 11, wherein determining the one or more positions of the one or more employers comprises:
determining that the first information comprises the occupation code, the experience level, the job title and the description on the first user;
identifying second information relating to each of the plurality of positions, the second information comprising an industry code, a job title and a job description;
determining that the experience level of the first user corresponds to no experience;
determining that the occupation code and the job title of the first user align with the industry code and the job title of a fourth position of the one or more positions, respectively;
performing a semantic analysis and a natural language processing (NLP) on (1) the description on the first user and (2) the job description of the third position;
determining, based on a result of the semantic analysis and the NLP, a degree of similarity between (1) the description on the first user and (2) the job description of the third position; and
determining that the degree of similarity is greater than a second threshold.

16. The method according to claim 11, further comprising:
receiving, via a second user interface, position information relating to a particular position of the plurality of positions of employers, the position information comprising at least one of an industry code, an experience level, and a job title, or a job description on the particular position;
determining, based on the position information, from among the plurality of users, one or more users; and
in response to the determined one or more users, sending a notification to an employer about the determined one or more users.

17. The method according to claim 11, wherein determining the one or more users, the one or more processors comprises:
determining that the position information comprises the industry code, the experience level, and the job title;
identifying candidate information relating to each of the plurality of users, the candidate information comprising an occupation code, an experience level and a job title; and
determining that the industry code, the experience level and the job title of the particular position align with the occupation code, the experience level and the job title of a second user of the plurality of users, respectively.

18. The method according to claim 11, wherein determining the one or more users comprises:
determining that the position information comprises the industry code and the experience level;
identifying candidate information relating to each of the plurality of users, the candidate information comprising an occupation code and an experience level;
determining that the occupation code of a third user of the plurality of users aligns with the industry code of the particular position;
determining, based on the industry code of the position information, a range of the experience level of the particular position; and
determining that the experience level of the second user falls within the range of the experience level of the particular position.

19. The method according to claim 11, wherein determining the one or more users comprises:
determining that the position information comprises the industry code, the job title, and the job description;
identifying candidate information relating to each of the plurality of users, the candidate information comprising an occupation code, a job title and a job function;
determining that the occupation code of a fourth user of the plurality of users is different from the industry code of the particular position;
performing a semantic analysis and a natural language processing (NLP) on (1) the occupation code, the job title, and the job function of the fourth user and (2) the industry code and the job description of the particular position;
determining, based on a result of the semantic analysis and the NLP, a degree of similarity between (1) the occupation code, the job title, and the job function of the fourth user and (2) the industry code and the job description of the particular position; and
determining that the degree of similarity is greater than a third threshold.

20. The method according to claim 11, wherein determining the one or more users comprises:
determining that the position information comprises the industry code, the experience level, the job title and the job description;
identifying candidate information relating to each of the plurality of users, the candidate information comprising an occupation code, a job title and a description on each user;
determining that the experience level of a fifth user of the plurality of users corresponds to no experience;
determining that the occupation code and the job title of the fifth user align with the industry code and the job title of the particular position, respectively;
performing a semantic analysis and a natural language processing (NLP) on (1) the description on the fifth user and (2) the job description of the particular position;
determining, based on a result of the semantic analysis and the NLP, a degree of similarity between (1) the description on the fifth user and (2) the job description of the particular position; and
determining that the degree of similarity is greater than a fourth threshold.
